(19) United States
(12) Patent Application Publication
(10) Pub. No.: US 2011/0238438 A1
(43) Pub. Date: Sep. 29, 2011

(54) AUTOMATED METHOD OF GRAPHICALLY DISPLAYING PREDICTED PATIENT ENROLLMENT IN A CLINICAL TRIAL STUDY

(75) Inventors: John W. HOURIET, JR., Yardley, PA (US); Allan D. HORWITZ, Philadelphia, PA (US); Ambalavanan SUBBIAH, Monmouth Junction, NJ (US)

(73) Assignee: NUMODA TECHNOLOGIES, INC., Philadelphia, PA (US)

(21) Appl. No.: 13/072,334

(22) Filed: Mar. 25, 2011

Related U.S. Application Data
(60) Provisional application No. 61/317,398, filed on Mar. 25, 2010.

(51) Int. Cl. G06Q 50/00; G06Q 10/00

(52) U.S. Cl. 705/2

(57) ABSTRACT

An automated method is provided of graphically displaying predicted patient enrollment in a clinical trial study. The study has a plurality of clinical sites for enrolling patients in the study. A database is provided that includes a patient enrollment rate for each clinical site and a date of initial patient enrollment for each clinical site. Clinical site launch data is entered into a user interface display screen, including a target number of patients to be enrolled in the study, and a target date for completing the enrollment of the target number of patients. A graphical display is then generated of a running total number of patients predicted to be enrolled in the study for a succession of time periods from the data that is provided and entered via the user interface display screen.

### CROSS-REFERENCE TO RELATED APPLICATIONS

This application claims priority to U.S. Provisional Patent Application No. 61/317,398 filed Mar. 25, 2010, which is incorporated by reference herein.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

Clinical trials are conducted to collect safety and efficacy data for new drugs or devices that a company wishes to make available to the public. A typical clinical trial for a new drug is performed by having a plurality of clinical research sites administer the drug to a plurality of patients who are screened and then enrolled at the respective sites. A clinical trial protocol will typically set forth the time frame of the clinical trial and the number of patients that are to be involved in the clinical trial. From this information, a target number of patients that should be enrolled in the clinical trial and a target date for reaching that enrollment number can be determined either directly or indirectly. However, even if these numbers are known, it is difficult for a clinical trial administrator to efficiently determine whether the target number of patients that should be enrolled in the clinical trial will actually be enrolled by the target date. If the target date is not met due to under-enrollment by the target date, the entire clinical trial may be delayed, which has potentially large negative consequences. If over-enrollment occurs by the target date, then the costs of the clinical trial may exceed budgeted amounts. It is very common for the plurality of clinical research sites to have different patient enrollment rates, and to enroll different numbers of patients, and to have different dates of initial patient enrollment, thereby further complicating the task of determining whether the target number of patients that should be enrolled in the clinical trial will actually be enrolled by the target date.

The present invention provides a system for simplifying the patient enrollment prediction process by allowing a user to graphically view enrollment status along a timeline.

### BRIEF SUMMARY OF THE INVENTION

One preferred embodiment of the present invention provides an automated method of graphically displaying predicted patient enrollment in a clinical trial study. The study has a plurality of clinical sites for enrolling patients in the study. A database is provided that includes a patient enrollment rate for each clinical site and a date of initial patient enrollment for each clinical site. Clinical site launch data is entered into a user interface display screen, including a target number of patients to be enrolled in the study, and a target date for completing the enrollment of the target number of patients. A graphical display is then generated of a running total number of patients predicted to be enrolled in the study for a succession of time periods from the data that is provided and entered via the user interface display screen.

### BRIEF DESCRIPTION OF THE DRAWINGS

The foregoing summary as well as the following detailed description of preferred embodiments of the invention, will be better understood when read in conjunction with the appended drawings. For the purpose of illustrating the invention, the drawings show presently preferred embodiments. However, the invention is not limited to the precise arrangements and instrumentalities shown. In the drawings:

FIG. 1 is the representation of table contents for use in accordance with one preferred embodiment of the present invention.

FIG. 2 is a user interface display screen for use in accordance with one preferred embodiment of the present invention.

FIGS. 3-7 are graphical displays in accordance with preferred embodiments of the present invention.

FIG. 8 is a schematic diagram of a hardware configuration in accordance with one preferred embodiment of the present invention.

FIGS. 9 and 10 are user interface display screens for use in accordance with preferred embodiments of the present invention.

FIG. 11 is a data table for use in accordance with one preferred embodiment of the present invention.

### DETAILED DESCRIPTION OF THE INVENTION

Certain terminology is used herein for convenience only and is not to be taken as a limitation on the present invention.

This patent application includes an Appendix having a file named appendix10001-47U1.txt, created on Mar. 25, 2010, and having a size of 8,628 bytes. The Appendix is incorporated by reference into the present patent application. One preferred embodiment of the present invention is implemented via the source code in the Appendix. The Appendix is subject to the “Copyright Notice and Authorization” stated above.

The present invention is described in the context of features provided in a web-based commercially available product called Site Launch Logistics System™ (SLLS) marketed by Numoda Corporation (Numoda), Philadelphia, Pa. In the present invention, Numoda functions as a service provider for hosting the SLLS.

### I. Overview of System

An automated method is provided of graphically displaying predicted patient enrollment in a clinical trial study. The study has a plurality of clinical sites for enrolling patients in the study. The method operates as follows:

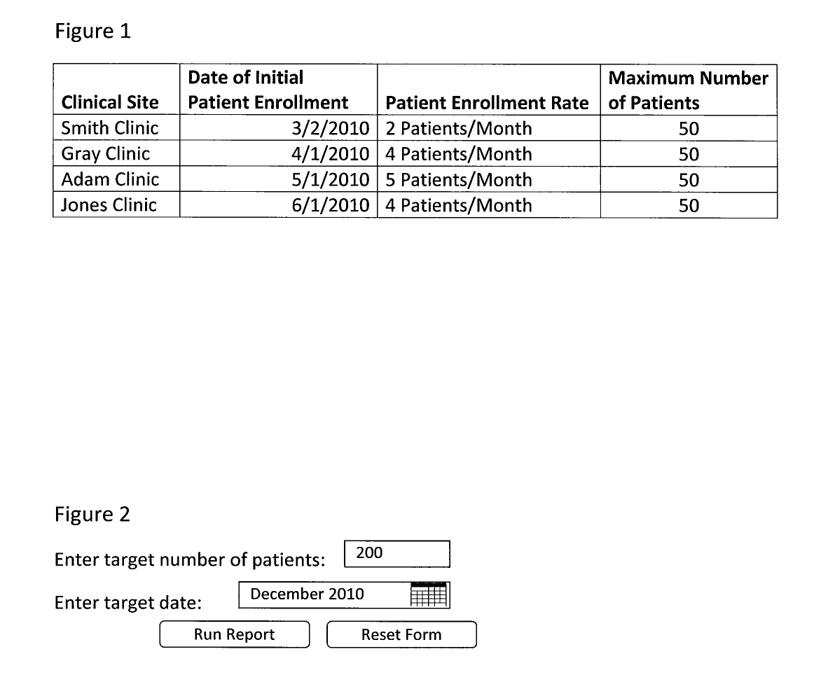

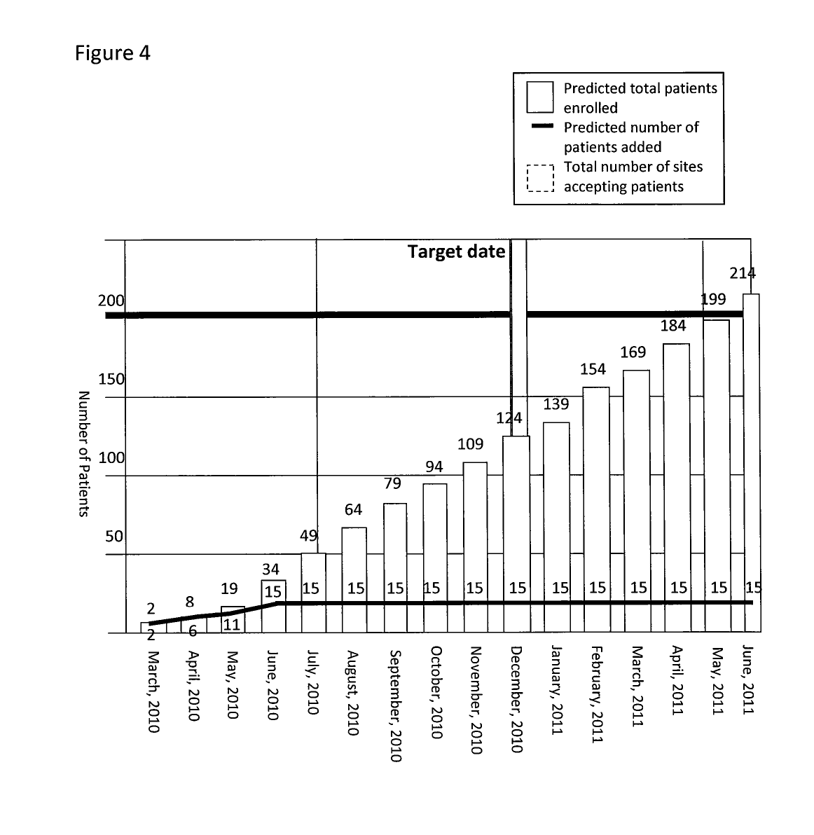

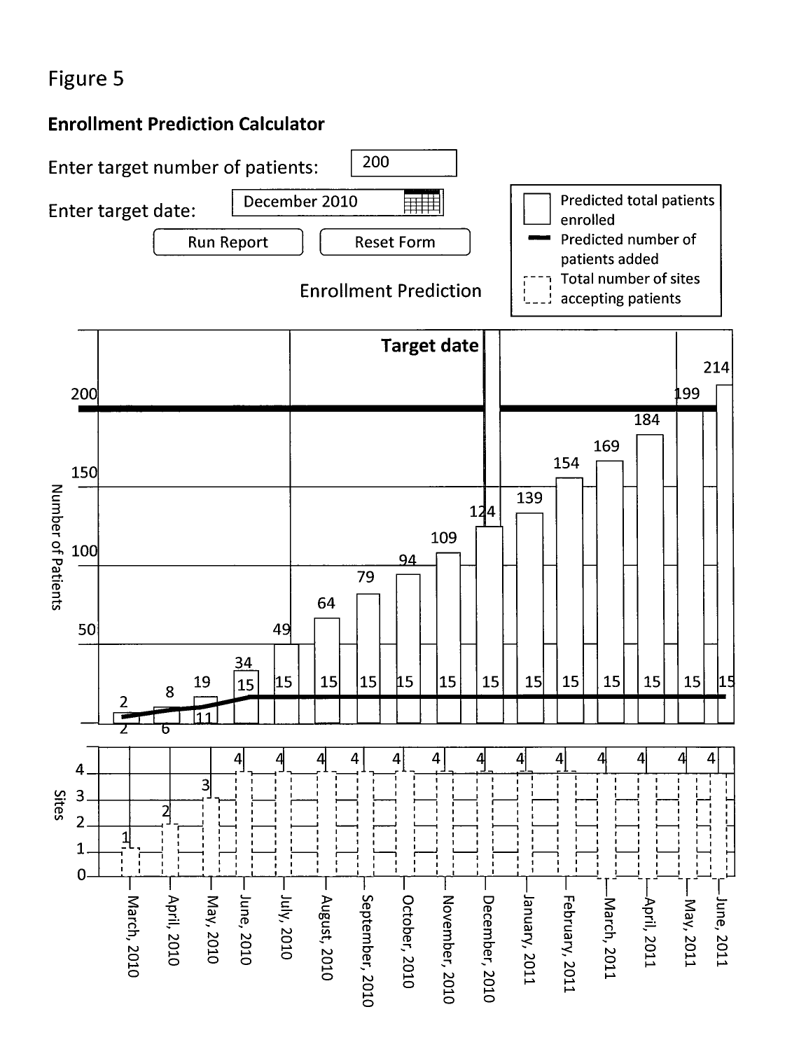

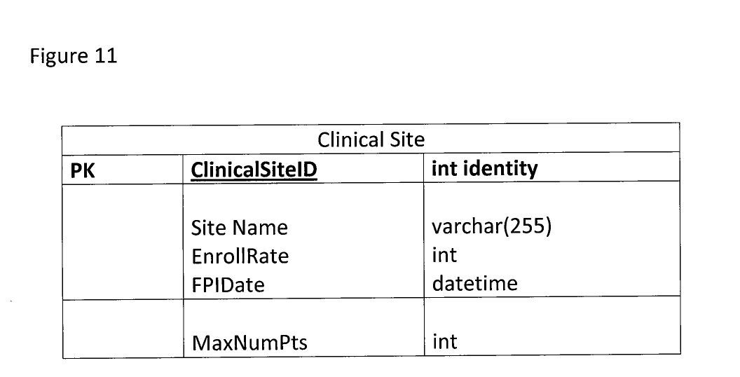

1. A database is provided that includes a patient enrollment rate (e.g., monthly enrollment rate), a date of initial patient enrollment for each clinical site (e.g., month and year of initial patient enrollment), and, optionally, the maximum number of patients that can be enrolled at each clinical site. See, for example, FIGS. 1 and 11.
2. Clinical site launch data is entered into a user interface display screen, including a target number of patients to be enrolled in the study, and a target date for completing the enrollment of the target number of patients. See, for example, FIG. 2.
3. A processor generates a graphical display of a running total number of patients predicted to be enrolled in the study for a succession of time periods, such as monthly, from the data provided in the database and from the user interface display screen. The graphical display preferably includes the target date displayed in the time period that matches the target date. See, for example, FIGS. 4 and 5.

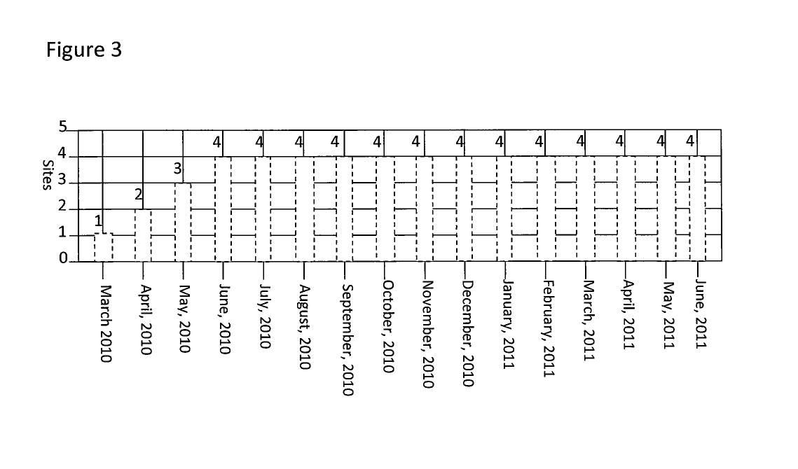

The processor may also generate a graphical display of the predicted number of additional patients enrolled for each time period from the data provided in the database and from the user interface display screen. See, for example, FIGS. 4 and 5. This graphical display may be superimposed on the graphical display of the running total number of patients predicted to be enrolled in the study for a succession of time periods (FIGS. 4 and 5), or it may be shown in a separate graphical display. The graphical display may also include a running total number of clinical sites that are enrolling patients (FIGS. 3 and 5). If the optional field of a maximum number of patients that can be enrolled at a clinical site is used, then the number of sites contributing to the running total would decrease if or when a clinical site reaches its maximum capacity, and if no new clinical sites begin enrolling patients.

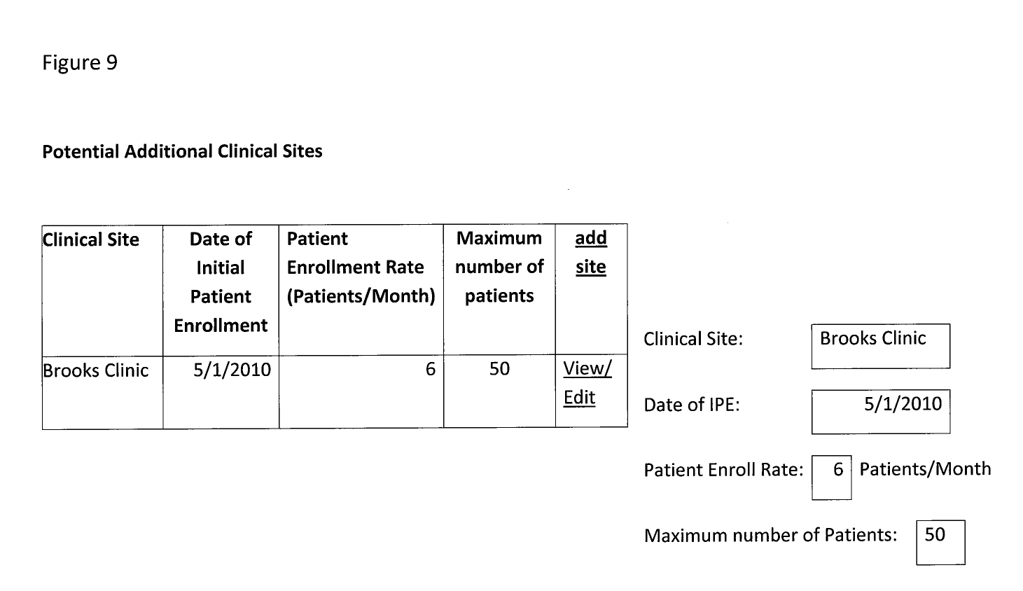

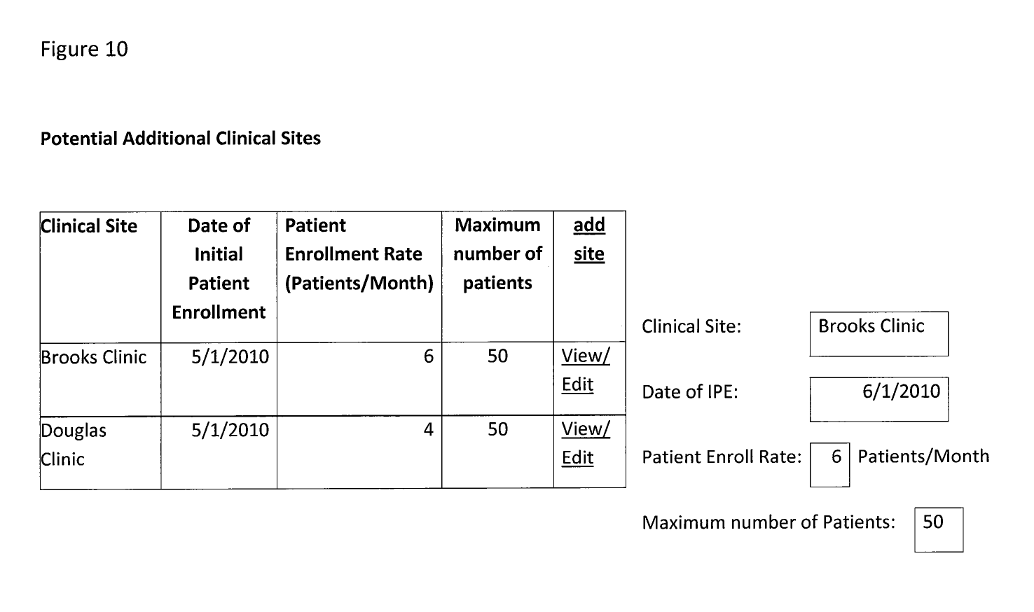

The user interface display screen may also allow for additional data to be entered, including one or more potential additional clinical sites for enrolling patients in the study, and the patient enrollment rate and a date of initial patient enrollment for such sites. See, for example, FIGS. 9 and 10. The additional data would then populate the database and the generated graphical display would show the effect of the one or more potential additional clinical sites on the running total number of patients predicted to be enrolled in the study for the succession of time periods.

In one preferred embodiment, when the target number of patients becomes equal to the running total number of patients predicted to be enrolled in the study, then the running total for subsequent time periods is made equal to the target number of patients. Preferably, the clinical sites would immediately stop enrolling patients when the target number of patients is met, and thus the running total would no longer increase.

The hardware for implementing the above-described process is referred to below as being a “calculator” or an “Enrollment Prediction Calculator” (EPC). In one commercialized implementation of the present invention, the calculator is provided as a module of the SLLS.

### II. Detailed Disclosure

As discussed above, the calculator displays predicted patient enrollment information based on data entered by the user. The patient enrollment data is displayed in a chart showing enrollment over time allowing the user to see whether or not enrollment numbers are met by a given target date.

A. System Description

The Enrollment Prediction Calculator (EPC) is preferably used at the point in the clinical trial process after the number of enrolled patients has been decided on and when the clinical trial study team (e.g., administrators) are determining what clinical sites they will need to set up for the study. By using clinical site data entered into a database, the calculator takes a few other additional input values and then creates a main chart or graph (FIG. 4) and a sub-chart or sub-graph (FIG. 3). The main chart is a combination column and line chart with a target date indicator. The sub-chart is a column chart which is displayed directly beneath the main chart (FIG. 5). Both charts share the same time points on their bottom axis. The left axis on the main chart indicates the predicted total number of patients enrolled. The left axis on the sub-chart represents the predicted number of sites enrolling patients. The target enrollment is preferably highlighted by a horizontal line so that the predicted enrollment on the target date can be quickly compared to the target enrollment to determine the magnitude of any shortfall of enrolled patients or excess number of enrolled patients.

The data entered in the database is shown in FIG. 1. Entered data includes the potential clinical sites, their respective dates of initial patient enrollment, their patient enrollment rate, and optionally, the maximum number of patients. This data, as it is displayed on the chart, can be seen in FIG. 3. The columns represent the cumulative number of sites that are enrolling patients. The number of sites will increase over time as more sites reach their date of initial patient enrollment.

FIG. 2 shows the data being collected through the user interface display screen. The target number of patients is the number of patients that the study team has determined is needed for the study. The target date is when the target number of patients is desired to be met. The cumulative number of enrolled patients is represented in the columns in FIG. 4. The number of patients enrolled for a given time period are represented by the line in FIG. 4. The target date indicator can also be seen in FIG. 4. This indicator allows the viewer to know whether or not they have met the study criteria.

The user can add and edit more clinical sites to be included in the site data using the Potential Additional Clinical Sites form (FIG. 9). This form collects the same data as the sites in the database in FIG. 10. The sites entered in FIG. 9 will then be used along with the sites entered in the database (FIG. 1) for creating the EPC charts.

In the examples above, line and bar graphs are used to illustrate the enrollment data. However, the scope of the present invention includes other types of graphical displays that communicate similar information.

B. Discussion of Example Shown in the Figures

FIG. 1 shows an example wherein four different clinical sites have different dates of initial patient enrollment and three different enrollment rates. In this example, each of the clinical sites can accept up to 50 patients. Clinical site enrollment rates may be influenced by many factors, such as the size and staffing of the site, the access to a pool of eligible patients, and recruitment efforts.

If the graphical display (e.g., FIG. 4) shows that the target enrollment will not be reached by the target date or that the target enrollment will be exceeded by the target date, then any of the following actions can be taken:

i. Entire clinical sites can be added or subtracted.

ii. The patient enrollment rate of selected sites may be increased (up to the known capacity of the selected sites) or decreased.

iii. The date of initial patient enrollment can be moved forward (if possible) or moved backwards.

iv. If the optional maximum number of patients field is factored into the prediction calculation and a clinical site has reached its maximum number of patients and the target enrollment was not reached by the target date, then the maximum number of patients can be increased if the capacity of the site has such flexibility. If the target enrollment will be exceeded by the target date, the maximum number of patients for one or more sites may be decreased. For example, the most costly sites or less desirable sites could be targeted first for reduction.

One benefit of the present invention is that these numbers can be easily and quickly manipulated via a simple user interface so as to test their effects on patient enrollment, without requiring the user to interface with spreadsheets, formulas or the like.

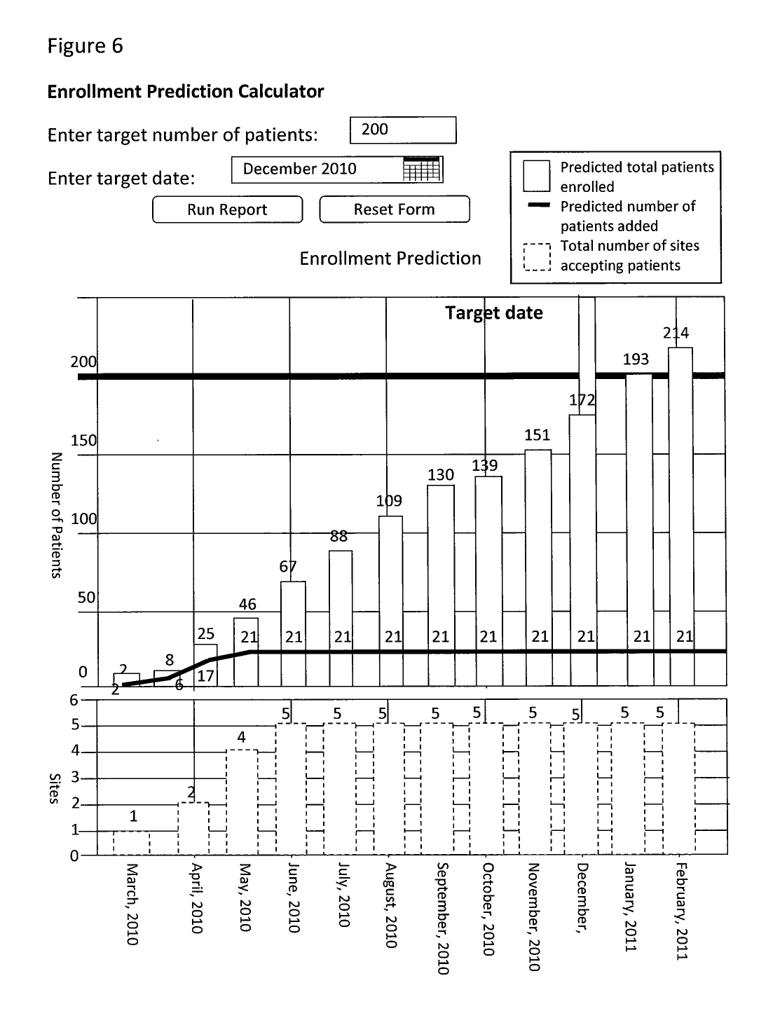

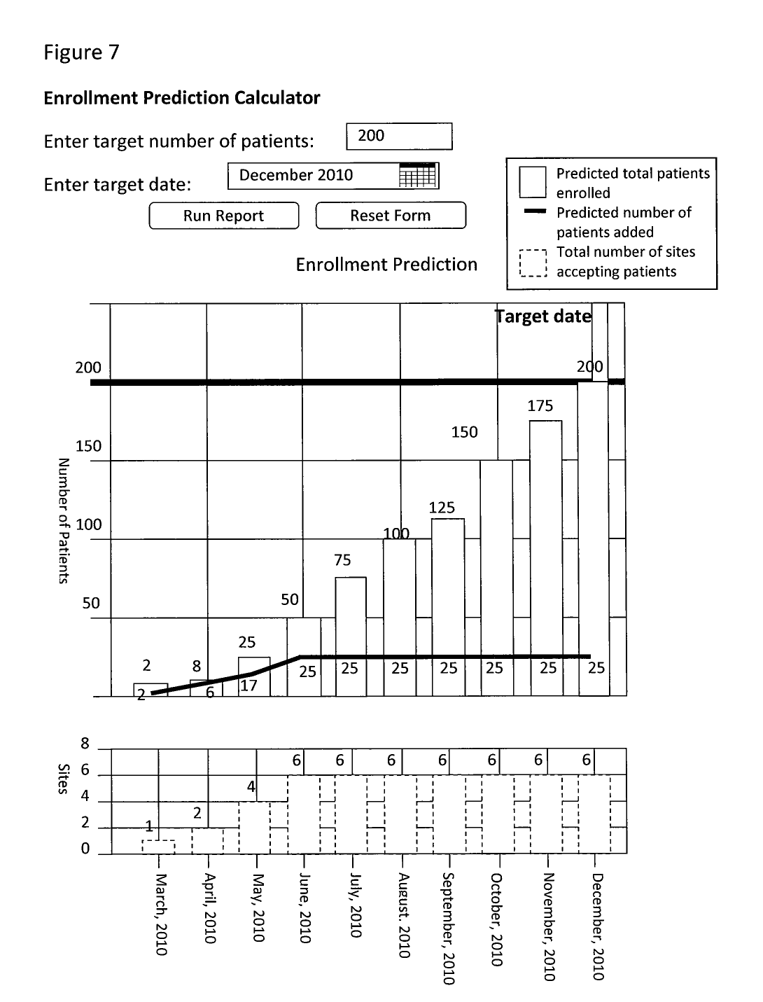

In the example of FIGS. 1-5, the number of enrolled patients is predicted to fall short of the target number of patients by 76 patients (200−124=76) on the target date. In this example, the study team either cannot or does not want to change the date of initial patient enrollment or the enrollment rate for any of the originally entered clinical sites, but is able to add new sites. The study team thus adds a first new site (Brooks Clinic) as shown in FIG. 9, and the graphical display is redrawn as shown in FIG. 6. The number of enrolled patients is still predicted to fall short of the target number of patients by 28 patients (200−172=28) on the target date. Accordingly, the study team adds another new site (Douglas Clinic) as shown in FIG. 10, and the graphical display is redrawn again as shown in FIG. 7. This display shows that the number of enrolled patients is now on track to exactly match the target number of patients by the target date. The study team can now proceed with the next stage of planning.

In one alternative embodiment of the present invention discussed above, the database of FIG. 1 also includes the maximum number of patients that can be enrolled at each clinical site. FIGS. 9, 10 and 11 also include this information. This field prevents unattainable enrollments from being factored into the prediction calculation. In the example shown in the figures, each of the clinical sites can accept more than the amount of patients that would be predicted to be enrolled upon reaching the target date (here, 50 patients at each site), and thus the maximum number of patients for these sites does not cause the unattainable enrollment problem. However, consider a scenario wherein a particular site cannot accept the number of patients that would be predicted to be enrolled upon reaching the target. For example, the Smith Clinic is predicted to enroll 20 patients by the target date. If the maximum number of patients for the Smith Clinic is 15 patients, then the prediction calculation must factor in this limitation so that when the month is reached where 15 patients are enrolled in the Smith Clinic, no more patients are added to the Smith Clinic in subsequent months. If this lower patient limit was set in FIG. 1, and no other changes were made to any of the other data fields of the database for any of the clinical sites, then FIG. 7 would show an enrollment shortfall on the target date instead of showing that the target number of patients is met. One or more adjustments would then need to be made to reach the target enrollment, such as adding one or more additional clinical sites, changing the enrollment rate or date of initial patient enrollment of one or more of the other clinical sites.

C. Hardware Configuration

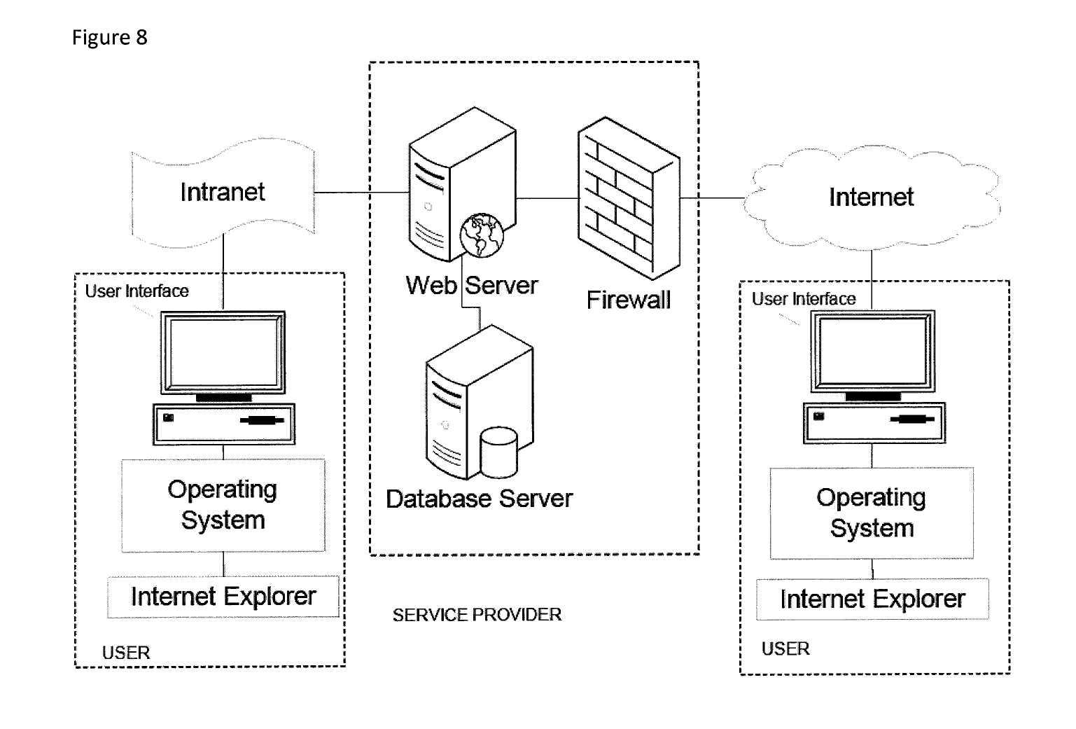

FIG. 8 shows one preferred hardware configuration having a plurality of users and a service provider, here, Numoda. The database server stores all of the data. FIG. 11 shows the data structure for a data table that stores variables entered and used in the calculation process. The web server (processor) handles all page requests and application processing. The web server (processor) also executes the software code in the Appendix.

The web server can be exposed to both an Intranet and the Internet or other form of electronic network. When exposed to the Internet, a firewall is used for security purposes. Client machines must be networked and require an Operating System capable of running Internet Explorer® or another graphical web browser.

The Appendix provides software code for implementing one preferred embodiment of the present invention shown in the figures and described above. However, the scope of the present invention is not limited to this particular implementation of the invention.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer readable media. The media is encoded with computer readable program code for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

While the present invention has been particularly shown and described with reference to one preferred embodiment thereof, it will be understood by those skilled in the art that various alterations in form and detail may be made therein without departing from the spirit and scope of the present invention.

What is claimed is:

1. An automated method of graphically displaying predicted patient enrollment in a clinical trial study, the study having a plurality of clinical sites for enrolling patients in the study, the method comprising:
(a) providing a database that includes for each clinical site:
(i) a patient enrollment rate, and
(ii) a date of initial patient enrollment;
(b) entering clinical site launch data into a user interface display screen, the data including:
(i) a target number of patients to be enrolled in the study, and
(ii) a target date for completing the enrollment of the target number of patients; and
(c) generating, using a processor, a graphical display of a running total number of patients predicted to be enrolled in the study for a succession of time periods from the data provided in step (a) and entered in step (b).

2. The method of claim 1 wherein step (c) further comprises generating, using the processor, a graphical display of the predicted number of additional patients enrolled for each time period from the data provided in steps (a)(i) and (a)(ii).

3. The method of claim 2 wherein the graphical display of the predicted number of additional patients enrolled for each time period is superimposed on the graphical display of the running total number of patients predicted to be enrolled in the study for a succession of time periods.

4. The method of claim 1 wherein step (b) further comprises entering into the user interface display screen additional data including:
(iii) one or more potential additional clinical sites for enrolling patients in the study, including for each clinical site (A) a patient enrollment rate, and (B) a date of initial patient enrollment,
and wherein step (a) further comprises populating the database with the additional data,
and wherein step (c) further comprises generating the graphical display from the data provided in step (a) and entered in step (b), including the additional data, the graphical display thereby showing the effect of the one or more potential additional clinical sites on the running total number of patients predicted to be enrolled in the study for the succession of time periods.

5. The method of claim 1 wherein the graphical display further includes the target date displayed in the time period that matches the target date.

6. The method of claim 1 wherein the succession of time periods is monthly and the patient enrollment rate is a monthly enrollment rate.

7. The method of claim 1 wherein the date of initial patient enrollment is a month and year.

8. The method of claim 1 wherein when the target number of patients becomes equal to the running total number of patients predicted to be enrolled in the study, then the running total for subsequent time periods is made equal to the target number of patients.

9. The method of claim 1 wherein the database in step (a) further provides for each clinical site:
(iii) a maximum number of patients, and wherein the graphical display in step (c) is generated from this additional data.

10. The method of claim 1 wherein step (c) further comprises generating, using the processor, a graphical display of a running total number of clinical sites that are enrolling patients from the data provided in step (a)(ii).

11. A computer program product for graphically displaying predicted patient enrollment in a clinical trial study, the study having a plurality of clinical sites for enrolling patients in the study, the computer program product comprising computer-readable media encoded with instructions for execution by a processor to perform a method comprising:
(a) providing a database that includes for each clinical site:
(i) a patient enrollment rate, and
(ii) a date of initial patient enrollment;
(b) entering clinical site launch data into a user interface display screen, the data including:
(i) a target number of patients to be enrolled in the study, and
(ii) a target date for completing the enrollment of the target number of patients; and
(c) generating a graphical display of a running total number of patients predicted to be enrolled in the study for a succession of time periods from the data provided in step (a) and entered in step (b).

12. The computer program product of claim 11 wherein step (c) further comprises generating a graphical display of the predicted number of additional patients enrolled for each time period from the data provided in steps (a)(i) and (a)(ii).

13. The computer program product of claim 11 wherein the graphical display of the predicted number of additional patients enrolled for each time period is superimposed on the graphical display of the running total number of patients predicted to be enrolled in the study for a succession of time periods.

14. The computer program product of claim 11 wherein step (b) further comprises entering into the user interface display screen additional data including:
(iii) one or more potential additional clinical sites for enrolling patients in the study, including for each clinical site (A) a patient enrollment rate, and (B) a date of initial patient enrollment,
and wherein step (a) further comprises populating the database with the additional data,
and wherein step (c) further comprises generating the graphical display from the data provided in step (a) and entered in step (b), including the additional data, the graphical display thereby showing the effect of the one or more potential additional clinical sites on the running total number of patients predicted to be enrolled in the study for the succession of time periods.

15. The computer program product of claim 11 wherein the graphical display further includes the target date displayed in the time period that matches the target date.

16. The computer program product of claim 11 wherein the succession of time periods is monthly and the patient enrollment rate is a monthly enrollment rate.

17. The computer program product of claim 11 wherein the date of initial patient enrollment is a month and year.

18. The computer program product of claim 11 wherein the database in step (a) further provides for each clinical site:
(iii) a maximum number of patients, and wherein the graphical display in step (c) is generated from this additional data.

19. The computer program product of claim 11 wherein when the target number of patients becomes equal to the running total number of patients predicted to be enrolled in the study, then the running total for subsequent time periods is made equal to the target number of patients.

20. The computer program product of claim 11 wherein step (c) further comprises generating a graphical display of a running total number of clinical sites that are enrolling patients from the data provided in step (a)(ii).
